(19) United States
(12) Patent Application Publication
(10) Pub. No.: US 2026/0145632 A1
(43) Pub. Date: May 28, 2026

(54) INFORMATION PROCESSING DEVICE

(71) Applicant: TOYOTA JIDOSHA KABUSHIKI KAISHA, Toyota-shi (JP)

(72) Inventors: Noriaki ITO, Okazaki-shi (JP); Takatsugu IKOMA, Hyogo-ken (JP); Yusuke TAMAYAMA, Tokyo (JP); Masahide UNNO, Toyota-shi (JP)

(73) Assignee: TOYOTA JIDOSHA KABUSHIKI KAISHA, Toyota-shi (JP)

(21) Appl. No.: 19/398,247

(22) Filed: Nov. 24, 2025

(30) Foreign Application Priority Data
Nov. 28, 2024 (JP) 2024-207322

(51) Int. Cl. B60R 21/017; B60R 16/033

(52) U.S. Cl. CPC B60R 21/0173; B60R 16/033

(57) ABSTRACT

In a vehicle that is equipped with a communication device that communicates with an external entity from the vehicle in accordance with a predetermined condition being satisfied, a first battery for supplying electric power to the communication device, a second battery that supplies electric power to the communication device when the supply of electric power from the first battery to the communication device is stopped, and a control unit, the control unit decides a charge level to which the second battery is to be charged, in accordance with a period.

### CROSS-REFERENCE TO RELATED APPLICATION

This application claims priority to Japanese Patent Application No. 2024-207322 filed on November 28, 2024, incorporated herein by reference in its entirety.

### BACKGROUND

### 1. Technical Field

The present disclosure relates to an information processing device.

### 2. Description of Related Art

A technology is known that provides a dedicated secondary battery in preparation for emergency calls (see, for example, Japanese Unexamined Patent Application Publication No. 2016-009250 (JP 2016-009250 A)).

### SUMMARY

An object of the present disclosure is to extend battery life.

One aspect of the present disclosure is an information processing device of a vehicle, the information processing device including a communication device that communicates with an external entity from the vehicle in accordance with a predetermined condition being satisfied, a first battery for supplying electric power to the communication device, a second battery that supplies electric power to the communication device when the supply of electric power from the first battery to the communication device is stopped, and a control unit, in which the control unit decides a charge level to which the second battery is to be charged, in accordance with a period.

Further, another aspect of the present disclosure is an information processing method in which a computer executes processing in the above-described information processing device, a program for causing the computer to execute this information processing method, and a storage medium in which this program is non-transitorily stored.

According to the present disclosure, life of the battery can be extended.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to a first embodiment;

FIG. 2 is a diagram showing a relation of transition in lowest air temperature, average air temperature, and highest air temperature, over the course of a year, with respect to a first period and a second period;

FIG. 3 is a flowchart of charging control in an in-vehicle device according to the first embodiment;

FIG. 4 is a diagram showing an example of temporal transition of temperature of a second battery, over the course of a year; and

FIG. 5 is a flowchart of charging control in an in-vehicle device according to a second embodiment.

### DETAILED DESCRIPTION OF EMBODIMENTS

There is known a communication device that enables a driver to make a call with an external operator when an emergency event occurs in a vehicle. This communication device operates by receiving supply of electric power from a first battery, which is a main battery of the vehicle. However, when the vehicle collides with an obstruction, for example, it is conceivable that a wire harness between the first battery and an emergency call device will be cut, or the first battery will be damaged. For this reason, installing a spare battery (hereinafter, also referred to as a second battery) is conceivable. This second battery is typically smaller than the first battery.

The second battery is configured to enable a call with an external operator when an emergency event occurs. Now, it is desirable for the driver to be able to make a ten-minute call to an external operator, for example, to be able to stand by for one hour, for example, or the like. Accordingly, the second battery needs to be charged to a certain charge level.

Now, when the second battery is fully charged, for example, when charging, deterioration of the second battery will progress. On the other hand, it is conceivable that deterioration of the second battery can be suppressed by restricting the charge level to which the second battery is charged to a certain extent. For example, by maintaining a charge level that is sufficient to allow a call to be made for the time that is required to notify an operator of the occurrence of an accident, a call to an operator can be placed when an accident occurs.

Moreover, it is desirable for the second battery that is installed in the vehicle to be able to operate at temperatures ranging from −40 °C to +90 °C, for example. Now, when the temperature of the second battery becomes low, the charge level of the second battery becomes low, output from the second battery decreases, and so forth. Accordingly, when low temperatures are taken into consideration, increasing the size of the second battery becomes necessary. Furthermore, deterioration of the second battery progresses under high temperatures, and accordingly when this deterioration is taken into consideration, increasing the size of the second battery becomes necessary.

On the other hand, it is desirable for the second battery to be compact in order to be installed in the vehicle. Furthermore, in terms of serviceability, it is desirable for the second battery to have a long life. That is to say, it is desirable to suppress deterioration of the second battery and also to reduce the size of the second battery.

With respect to the foregoing, an information processing device that is one aspect of the present disclosure is an information processing device of a vehicle, the information processing device including a communication device that communicates with an external entity from the vehicle in accordance with a predetermined condition being satisfied, a first battery for supplying electric power to the communication device, a second battery that supplies electric power to the communication device when the supply of electric power from the first battery to the communication device is stopped, and a control unit, in which the control unit decides a charge level to which the second battery is to be charged, in accordance with a period.

The communication device enables communication with an external entity from the vehicle in accordance with the predetermined condition being satisfied. The predetermined condition includes, for example, occurrence of an emergency event, application of a predetermined impact to the vehicle, pressing of a call button that is disposed in the vehicle, and so forth. Communication with an external entity from the vehicle includes calls with an operator in an external entity from the vehicle. The first battery is, for example, the main battery of the vehicle, and is a battery with a greater chargeable capacity than that of the second battery. The second battery is, for example, a spare battery. The second battery is configured to enable the communication device to communicate with an external entity from the vehicle even when the supply of electric power from the first battery to the communication device is interrupted. The first battery and the second battery supply electric power to the communication device through separate paths.

The second battery may supply electric power to the communication device even when the predetermined condition is not satisfied, or may supply electric power to the communication device just when the predetermined condition is satisfied. The charge level of the second battery decreases due to discharging even in a state in which no electric power is being supplied therefrom to the communication device. Accordingly, the control unit executes control to charge the second battery. In this way, the control unit restores the charge level of the second battery. The control unit then decides the charge level to which the second battery is to be charged, in accordance with the period. The charge level to which the second battery is to be charged may be the charge level of the second battery after charging. This charge level may also be a State of Charge (SOC). Also, the charge level of the second battery after charging may be, for example, a charge level that allows for a desired duration of time for a call with an operator, to which a margin is added. As another example, the charge level of the second battery after charging may be, for example, a charge level that allows for a desired duration of standby time, to which a margin is added. The duration of time over which a call can be placed, the duration of time over which standby can be performed, or the like, may be a value that is set in accordance with regulations. The period may be a date, a month, a season, or the like. As yet another example, the period may indicate each of periods when a year is divided into a plurality of periods according to temperature. Charging of the second battery may be performed from the first battery, or from a generator provided in the vehicle.

Now, when comparing the second battery at high temperature and low temperature, a charge level that is required to obtain the same duration of time over which a call can be placed is greater at low temperatures. Accordingly, the charge level to which the second battery is charged may conceivably be decided assuming that the second battery will be at a low temperature. However, when the second battery is at a high temperature, this will result in charging being performed more than necessary, which causes the deterioration thereof to progress. Accordingly, progression of the deterioration of the second battery can be suppressed by not charging the second battery more than necessary.

Deciding the charge level with which the second battery is to be charged in accordance with the period enables an appropriate charge level to be decided in accordance with the period. For example, the control unit may reduce the charge level to which the second battery is to be charged, during a period of high temperature, as compared with during a period of low temperature. This enables progression of the deterioration of the second battery to be suppressed while ensuring the charge level that is required for communication by the communication device. Note that the control unit or the second battery may be included in the communication device.

Hereinafter, embodiments of the present disclosure will be described with reference to the drawings. Configurations of the following embodiments are exemplary, and the present disclosure is not limited to the configurations of the embodiments. Also, the following embodiments can be maximally combined.

### First Embodiment

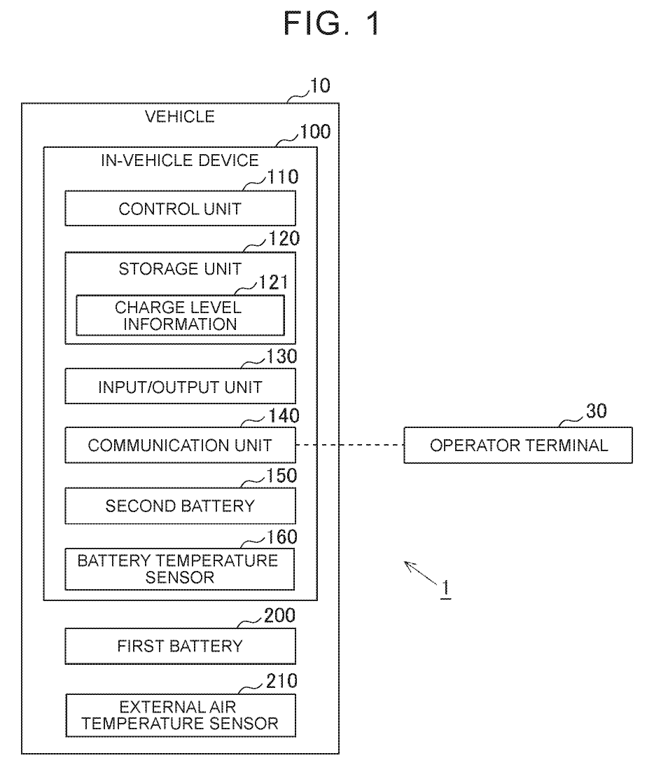

FIG. 1 is a diagram illustrating a schematic configuration of a system 1 according to an embodiment. The system 1 according to the present embodiment is configured including a vehicle 10 and an operator terminal 30. The vehicle 10 is a connected car that has a communication function with an external network. The vehicle 10 is configured including an in-vehicle device 100, a first battery 200, and an external air temperature sensor 210. The first battery 200 is a main battery of the vehicle 10 and supplies electric power to various types of equipment of the vehicle 10. The first battery 200 is, for example, a lithium-ion battery or a lead battery, but is not limited thereto. The external air temperature sensor 210 is a sensor that detects the air temperature outside of the vehicle 10. The operator terminal 30 is a terminal that is used by an operator to have a call with the driver of the vehicle 10.

The in-vehicle device 100 is a device that performs wireless communication with the external network. The in-vehicle device 100 is, for example, a computer that is installed in the vehicle 10, such as a Data Communication Module (DCM), a head unit, an automotive navigation system, or the like. The in-vehicle device 100 can communicate with the operator terminal 30 that is connected to a network. The in-vehicle device 100 is configured including a control unit 110, a storage unit 120, an input/output unit 130, a communication unit 140, a second battery 150, and a battery temperature sensor 160. Note that the in-vehicle device 100 is an example of a communication device.

The control unit 110 is a computation device that governs control performed by the in-vehicle device 100. The control unit 110 can be realized by an arithmetic processing device such as a central processing unit (CPU) or the like. The control unit 110 may be configured including random access memory (RAM), read-only memory (ROM), a cache memory, or the like.

The storage unit 120 is configured including a main storage device and an auxiliary storage device. The main storage device is memory in which programs that are executed by the control unit 110, and data that is used by the control programs, are loaded. The auxiliary storage device is a device in which programs that are executed by the control unit 110, and data used by the control programs, are stored.

Also, the storage unit 120 stores charge level information 121. The charge level information 121 is information relating to the charge level to which the second battery 150 is to be charged. The charge level information 121 includes information that indicates a relation between periods and the charge level to which the second battery 150 is to be charged.

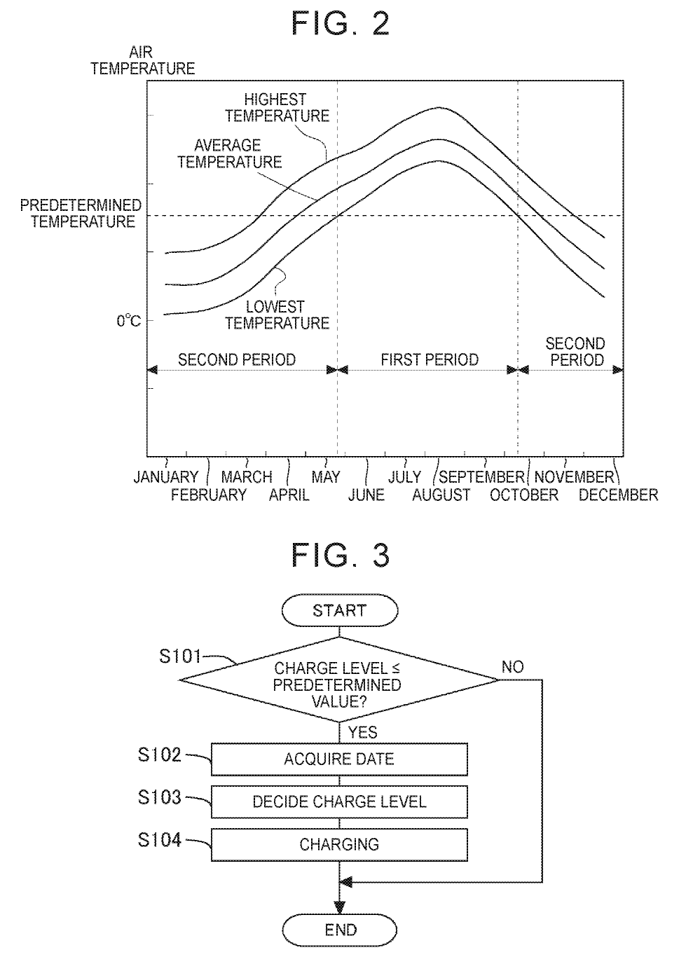

FIG. 2 is a diagram showing a relation of transition in lowest air temperature, average air temperature, and highest air temperature, over the course of a year, with respect to a first period and a second period. The transition in the lowest air temperature, the average air temperature, and the highest air temperature, over the course of a year, corresponds to temperatures in each region or nation, for example. The first period is a period of higher temperatures than the second period. In FIG. 2, a period in which the lowest air temperature is higher than a predetermined temperature (for example, 15°C) is defined as the first period, and a period in which the lowest air temperature is equal to or lower than the predetermined temperature is defined as the second period. The predetermined temperature may be set, for example, such that a year is divided into two equal periods, or may be set so as to suppress progress of deterioration of the second battery 150, or may be set arbitrarily. The control unit 110 acquires the date of the current point in time, for example, and finds whether this date falls in the first period or the second period, based on FIG. 2. Information regarding the relation between the date, and the first period and second period, is included in the charge level information 121. Furthermore, the control unit 110 decides the charge level to which the second battery 150 is to be charged, based on information that indicates the relation between the period and the charge level to which the second battery 150 is to be charged, that is included in the charge level information 121.

Note that as another example, the charge level to which the second battery 150 is to be charged, corresponding to each of the first period and the second period, may be stored in the storage unit 120. In this case, the charge level to which the second battery 150 is to be charged is lower in the first period than it is in the second period. However, this is not restrictive, and for example, a year may be divided into a plurality of periods, and the charge level to which the second battery 150 is to be charged may be decided in accordance with the average air temperature in each period, for example. In this case, the higher the average air temperature of a period is, the lower the charge level to which the second battery 150 is to be charged becomes.

The input/output unit 130 is means for receiving input operations that are performed by the user, and presenting information to the user. Specifically, the input/output unit 130 includes a device for performing input, such as a microphone or the like, and a device for performing output, such as a speaker or the like. The input/output unit 130 is configured to acquire utterance of the user, and also output utterance of the operator that is transmitted from the operator terminal 30.

The communication unit 140 is communication means for connecting the in-vehicle device 100 to the network. The communication unit 140 is a circuit for communicating with other devices (e.g., operator terminal 30 or the like) via the network, by using a wireless communication network such as, for example, a mobile communication service (e.g., a telephone communication network such as sixth generation (6G), fifth generation (5G), fourth generation (4G), third generation (3G), long term evolution (LTE) or the like), Wi-Fi (registered trademark), Bluetooth (registered trademark), and so forth.

The second battery 150 is a battery that supplies electric power to the in-vehicle device 100. Note that normally, the first battery 200 supplies electric power to the in-vehicle device 100. Also, the first battery 200 can also charge the second battery 150 by supplying electric power to the second battery 150. The second battery 150 is a lithium-ion battery, for example, but is not limited thereto. The battery temperature sensor 160 is a sensor that detects temperature of the second battery 150.

Now, in a case in which the first battery 200 malfunctions, or wire breakage occurs in a wire harness from the first battery 200 to the in-vehicle device 100, such that electric power can no longer be supplied from the first battery 200 to the in-vehicle device 100, electric power will be supplied to the in-vehicle device 100 from the second battery 150. For example, in a case in which the vehicle 10 collides with an obstruction and the first battery 200 is damaged, electric power can be supplied from the second battery 150 to the in-vehicle device 100, enabling the user of the vehicle 10 to place a call to an operator via the communication unit 140. The charge level and the output power of this second battery 150 change, deterioration progresses, and so forth, depending on the temperature.

Therefore, suppressing deterioration of the second battery 150, by restricting the charge level of the second battery 150 to a certain degree, is conceivable. Being able to suppress deterioration of the second battery 150 would enable reduction in the size of the second battery 150.

Accordingly, the control unit 110 charges the second battery 150 so as to keep the charge level of the second battery 150 to a minimum that is necessary. Now, the charge level of the second battery 150 decreases at low temperatures, and accordingly the charge level to which the second battery 150 is to be charged needs to be a relatively high charge level, but at high temperatures, there is no need for the charge level to which the second battery 150 is to be charged to be as high as that at low temperatures. Furthermore, making the charge level to be relatively low when charging the second battery 150 at high temperatures can suppress progress of deterioration of the second battery 150. However, deciding the charge level to which the second battery 150 is to be charged, based solely on the temperature at the point in time of charging the second battery 150, would result in being readily affected by temperature fluctuations, and there is a risk that an appropriate charge level could not be decided.

Accordingly, the control unit 110 decides the charge level to which the second battery 150 is to be charged in accordance with the period. In the first period shown in FIG. 2, the charge level to which the second battery 150 is to be charged is decided such that the charge level of the second battery 150 is lower than that in the second period. The control unit 110 then charges the second battery 150 from the first battery 200, with the charge level that is decided as a target value. Note that as shown in FIG. 2, the charge level to which the second battery 150 is to be charged is determined based on the lowest air temperature for the same day in the past. However, temperatures may vary from year to year, and accordingly the charge level to which the second battery 150 is to be charged may be decided by further taking into account the actual external air temperature, for example. For example, the charge level to which the second battery 150 is to be charged may be corrected such that the lower the actual lowest external air temperature is, as compared with the lowest temperature for the same day in the past that is stored in the storage unit 120, the higher the charge level to which the second battery 150 is to be charged is set to be. The external air temperature at this time is detected by the external air temperature sensor 210.

Note that the series of processing that is executed by the in-vehicle device 100 can be executed by hardware, or can be executed by software.

The operator terminal 30 is a small computer such as, for example, a smartphone, a mobile phone, a tablet terminal, a personal information terminal, a wearable computer (smart watch etc.), a personal computer (PC), or the like. The operator terminal 30 is configured to enable an operator to make a call with the user of the vehicle 10.

Next, charging control in the in-vehicle device 100 will be described. FIG. 3 is a flowchart of the charging control in the in-vehicle device 100 according to a first embodiment. The processing shown in FIG. 3 is executed in the in-vehicle device 100 at predetermined time intervals.

In step S101, the control unit 110 determines whether the charge level of the second battery 150 is equal to or lower than a predetermined value. The predetermined value is stored in advance in the storage unit 120 as the charge level to which the second battery 150 needs to be charged. When the control unit 110 makes an affirmative determination in step S101, the processing advances to step S102, and when the determination is negative, this routine is ended.

In step S102, the control unit 110 obtains the current date. The date may be obtained based on a clock that is built into the in-vehicle device 100, for example, may be obtained from a Global Positioning System (GPS) device that is used in an automotive navigation system, or may be obtained from an external server that provides the date, via the communication unit 140. Upon completing the processing of step S102, the control unit 110 executes processing of step S103.

In step S103, the control unit 110 decides the charge level to which the second battery 150 is to be charged, in accordance with the date that is acquired in step S102. At this time, the control unit 110 reduces the charge level to which the second battery 150 is to be charged, in a period in which the temperature is high, as compared to in a period in which the temperature is low. The control unit 110 refers to the charge level information 121 to acquire the charge level to which the second battery 150 is to be charged, in accordance with the date. In this case, the charge level in accordance with the date is stored in the storage unit 120. Note that as another example, whether the current date is in the first period or in the second period may be determined from the date, so as to acquire the charge level in accordance with the first period or second period that is determined. In this case, the relation between the date and the first period or the second period is stored in the storage unit 120. Furthermore, charge levels corresponding to the first period and the second period are stored in the storage unit 120. Upon completing the processing of step S103, the control unit 110 executes processing of step S104. In step S104, the control unit 110 charges the second battery 150 based on the charge level to which the second battery 150 is to be charged that is decided in step S103. Then, when the charge level of the second battery 150 reaches the charge level that is decided in step S103, the control unit 110 ends this routine.

Note that while the charge level to which the second battery 150 is to be charged is decided in accordance with the date in the present embodiment, this is not restrictive, and the charge level to which the second battery 150 is to be charged may be decided in accordance with the season, for example. For example, the charge level to which the second battery 150 is to be charged may be decided depending on whether it is spring, summer, autumn, or winter. Also, for example, the charge level to which the second battery 150 is to be charged may be different each month. Also, the charge level to which the second battery 150 is to be charged may be corrected in accordance with, for example, an average value of the actual external air temperature in the past (e.g., average value of external air temperature over the past month). Also, the charge level to which the second battery 150 is to be charged may be corrected in accordance with the location of the vehicle 10 (e.g., nation or latitude), for example. For example, multiple relations between dates and charge levels to which the second battery 150 is to be charged, in accordance with the location of the vehicle 10, may be stored in the storage unit 120, and the relation between the date of usage and the charge level to which the second battery 150 is to be charged may be decided in accordance with the location of the vehicle 10.

As described above, according to the present embodiment, the charge level to which the second battery 150 is to be charged is changed depending on the period, and accordingly the charge level to which the second battery 150 is to be charged that is suitable for that period can be decided. Accordingly, progression of deterioration of the second battery 150 can be suppressed. Also, suppressing deterioration of the second battery 150 enables reduction in the size of the second battery 150.

### Second Embodiment

In the present embodiment, the degree of deterioration of the second battery 150 (hereinafter also referred to as deterioration level) is estimated, and the charge level to which the second battery 150 is to be charged is corrected in accordance with this deterioration level. As the deterioration level of the second battery 150 increases, the charge level and output amount of the second battery 150 decrease, and accordingly the charge level to which the second battery 150 is to be charged is increased to compensate for this decrease in the charge level and the output amount. The charge level to which the second battery 150 is to be charged before correction is, for example, the charge level to which the second battery 150 is to be charged that is described in the first embodiment.

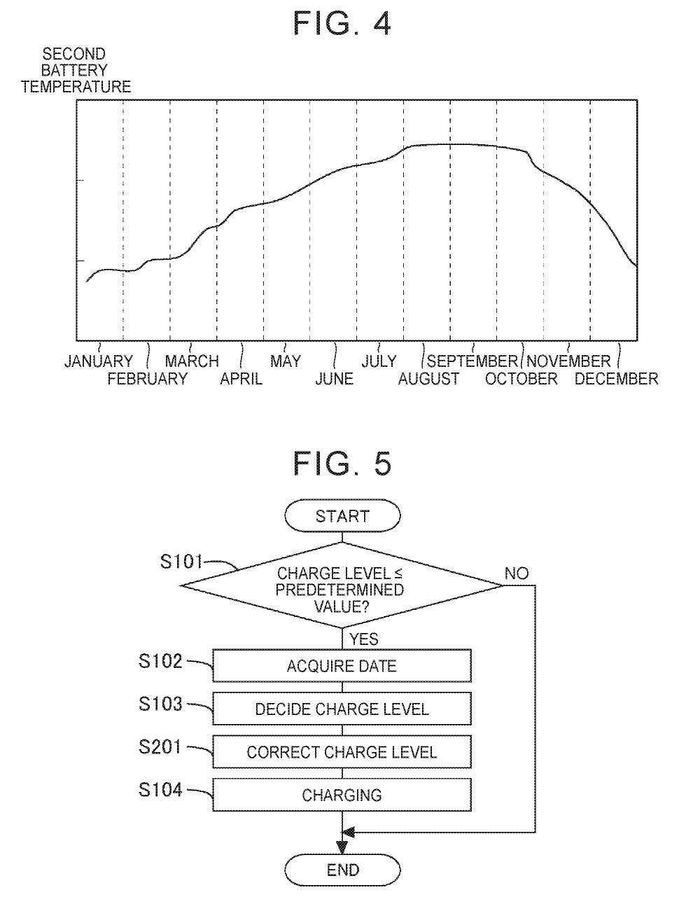

The deterioration of the second battery 150 progresses in accordance with the temperature of the second battery 150. Now, FIG. 4 is a diagram showing an example of temporal transition of the temperature of the second battery 150 over the course of a year. The deterioration of the second battery 150 progresses more quickly as the temperature of the second battery 150 increases, and accordingly an integral value of the temperature of the second battery 150 has a correlation with the deterioration level of the second battery 150. Thus, a correction amount of the charge level to which the second battery 150 is to be charged can be calculated based on the integral value of the temperature of the second battery 150 (i.e., the area of a region below the solid line in FIG. 4).

The control unit 110 detects the temperature of the second battery 150 and performs storage thereof in the storage unit 120. The control unit 110 then integrates the temperature of the second battery 150. A relation between this integral value, and the correction amount for the charge level to which the second battery 150 is to be charged, is stored in advance in the storage unit 120. The control unit 110 then decides the charge level to which the second battery 150 is to be charged, as described in the first embodiment, further calculates the correction amount, and corrects the charge level to which the second battery 150 is to be charged by adding the correction amount to the charge level to which the second battery 150 is to be charged. Note that the temperature of the second battery 150 is detected by the battery temperature sensor 160. Also, as another example, the control unit 110 may estimate the temperature of the second battery 150 from the external air temperature.

Next, charging control in the in-vehicle device 100 will be described. FIG. 5 is a flowchart of charging control in the in-vehicle device 100 according to the second embodiment. Processing shown in FIG. 5 is executed in the in-vehicle device 100 at predetermined time intervals. Note that the steps in which the same processing as that in the routine that is shown in FIG. 3 is executed are denoted by the same reference signs, and description thereof will be omitted. Assumption will be made that the storage unit 120 stores information regarding the temperature of the second battery 150 from when new. For example, the control unit 110 periodically detects the temperature of the second battery 150 and stores the temperature in the storage unit 120.

In the routine shown in FIG. 5, when the control unit 110 completes the processing of step S103, the processing advances to step S201. In step S201, the control unit 110 calculates a correction amount for the charge level to which the second battery 150 is to be charged, and corrects this charge level. The control unit 110 calculates an integral value by integrating the temporal transition in temperature over time from when the second battery 150 was new. Furthermore, the correction amount is calculated based on this integral value. The relation between the integral value and the correction amount is stored in the storage unit 120. After calculating the correction amount, the control unit 110 adds the correction amount that is calculated to the charge level to which the second battery 150 is to be charged, decided in step S103, thereby correcting this charge level.

As described above, according to the present embodiment, the charge level to which the second battery 150 is to be charged is corrected in accordance with the deterioration level of the second battery 150, and accordingly the charge level to which the second battery 150 is to be charged can be further optimized.

### Other Embodiments

The above-described embodiment is merely an example, and the present disclosure may be implemented modified as appropriate, without departing from the scope thereof. The processing and means described in the present disclosure can be freely combined and implemented as long as no technical contradiction occurs. Also, processing described as being performed by a single device may be executed by a plurality of devices in cooperation. Alternatively, processing described as being performed by different devices may be executed by one device. In the computer system, what sort of hardware configurations (server configurations) are to be employed for realizing each function can be flexibly changed.

What is claimed is:

1. An information processing device of a vehicle, the information processing device comprising:
a communication device that communicates with an external entity from the vehicle in accordance with a predetermined condition being satisfied;
a first battery for supplying electric power to the communication device;
a second battery that supplies electric power to the communication device when the supply of electric power from the first battery to the communication device is stopped; and
a control unit, wherein
the control unit decides a charge level to which the second battery is to be charged, in accordance with a period.

2. The information processing device according to claim 1, wherein the control unit reduces the charge level to which the second battery is to be charged, during a period of high temperature, as compared with during a period of low temperature.

3. The information processing device according to claim 1, further comprising a storage unit that stores a relation between the period and the charge level to which the second battery is to be charged, wherein the control unit decides the charge level to which the second battery is to be charged, in accordance with the period that is acquired and the relation that is stored in the storage unit.

4. The information processing device according to claim 1, wherein the control unit corrects the charge level to which the second battery is to be charged, based on a transition in temperature of the second battery.
